(19) United States
(12) Patent Application Publication
(10) Pub. No.: US 2014/0207489 A1
(43) Pub. Date: Jul. 24, 2014

(54) MAPPING OF HEALTH DATA

(71) Applicants: Frank Wartena, Eindhoven (NL); Johan Muskens, Hurwenen (NL); Ronald Leo Christiaan Koymans, Eindhoven (NL); Rob Theodorus Udink, Lieshout (NL); Lucien Johannes Maria Jaegers, Geldrop (NL); Bart Meulenbroeks, Eindhoven (NL)

(72) Inventors: Frank Wartena, Eindhoven (NL); Johan Muskens, Hurwenen (NL); Ronald Leo Christiaan Koymans, Eindhoven (NL); Rob Theodorus Udink, Lieshout (NL); Lucien Johannes Maria Jaegers, Geldrop (NL); Bart Meulenbroeks, Eindhoven (NL)

(73) Assignee: KONINKLIJKE PHILIPS ELECTRONICS N.V., EINDHOVEN (NL)

(21) Appl. No.: 14/125,669

(22) PCT Filed: Jun. 22, 2012
(86) PCT No.: PCT/IB2012/053165

§ 371 Date: Feb. 24, 2014

(30) Foreign Application Priority Data
Jun. 22, 2011 (EP) 11171008.3

(51) Int. Cl. G06F 19/00

(52) U.S. Cl. CPC G06F 19/3487
USPC 705/3

(57) ABSTRACT

A method of mapping health data acquired by a measurement device (101a-c) which is useable by a plurality of users to an appropriate health record is described. The method involves receiving (201) new health data acquired by the measurement device (101a-c); identifying (206; 209) the user to which the new health data relates; and mapping (207) the health data to at least one health record for said user; wherein the step of identifying the user to which the new health data relates comprises: identifying at least one item of context data associated with said new health data; and determining (205, 208) whether said context data corresponds to a known context for at least one user. The context data is data regarding the circumstances in which the new health data was acquired and/or the relationship of the new health data to other measurement data associated with a particular user.

### FIELD OF THE INVENTION

The present invention relates to mapping of personal health data to appropriate health records of one or more health related services, especially in a telehealth system.

### BACKGROUND OF THE INVENTION

Various personal telehealth systems have been proposed. Conventionally such telehealth systems involve a patient being provided with one or more measurement devices so as to acquire their own health data which is subsequently provided to a healthcare service. Typically therefore the measurement devices are uniquely associated with an individual patient and all data collected is provided to a single backend service.

Increasingly however a greater range of measurement devices may be used to acquire health data as part of general health monitoring and such measurement devices may be useable by more than one individual. For example, a weighing scale or blood pressure monitor may be used by more than one family member as part of general heath monitoring.

Also, increasingly there may be multiple backend services to which the acquired health data, or a subset thereof, should be sent. For example a patient with diabetes may acquire measurement data such as weight, blood pressure, blood glucose level etc. which should be sent to a diabetes service. Separately at least some of the same data, such as weight should also be provided to a weight loss service.

### SUMMARY OF THE INVENTION

It is therefore an object of the invention to provide methods and apparatus that can correctly map personal health data to appropriate health record of one or more health related services.

Thus according to the present invention there is provided a method of mapping health data acquired by a first measurement device which is useable by a plurality of users to an appropriate health record, the method comprising: receiving new health data acquired by said first measurement device; identifying the user to which the new health data relates; and mapping said health data to at least one health record for said user; wherein the step of identifying the user to which the new health data relates comprises: identifying at least one item of context data associated with said new health data; and determining whether said context data corresponds to a known context for at least one user.

The context data may comprise at least one of: the time of acquisition of the new health data; other measurement data acquired simultaneously within a set period of said new health data; the location that the measurement was taken; the measurement values of the new health data; and the relative proximity of the first measurement device to at least one personal device associated with a specific user at the time of measurement.

For example the context data may comprise the time of acquisition of the new health data and the known context may comprise known times for measurements using said first measurement device for a user.

The context data may additionally or alternatively comprise other measurement data acquired within a set period of said new health data, and the known context may comprise an indication of at least a second measurement device often used simultaneously or consecutively with said first measurement device. The method may therefore comprise identifying whether any other measurement data was acquired using said second measurement device within a set period of said new health data. Such other measurement data acquired using said second measurement device may be associated with a specific user and the presence of such other measurement data can be used as an indication that new health data acquired using the first measurement device also corresponds to said specific user.

The context data may additionally or alternatively comprise the location that the measurement of the new health data was taken and the known context may comprise one or more known locations for measurements using said first measurement device for a user.

In some embodiments the context data may additionally or alternatively comprise the measurement values of the new health data and the known context may comprise an expected value based on previous measurement values for a user. The expected value could comprise a range of value determined using a physiological model and previous measurement values for a user.

The context data may additionally or alternatively comprise the relative proximity of the first measurement device to at least one personal device associated with a specific user at the time of measurement and the known context may comprise an identification of known personal devices and the associated users. Such a personal device may comprise a measurement device associated with a single user only or, in one embodiment, a mobile telephone of a user. The relative proximity may be determined by determining whether one or more of the first measuring device and the at least one personal device were in range of a hub apparatus at the time of measurement. The presence of a personal device associated with a specific user in relative proximity to the first measuring device at the time that the measurement was taken may be used as an indication that new health data acquired using the first measurement device corresponds to said specific user. Additionally or alternatively the absence of a personal device associated with a specific user in relative proximity to the first measuring device at the time that the measurement was taken may be used as an indication that new health data acquired using the first measurement device does not correspond to said specific user.

The new health data may be tagged with a user ID and the method may involve determining whether the context data corresponds to a known context for the user corresponding to said user ID so as to verify the user ID.

The method may be repeated for data received from a plurality of measuring devices.

The step of mapping the new health data to at least one health record may comprise identifying one or more specified health records based on the identified user and measurement device.

The method may be performed by a telehealth hub apparatus configured to receive data from the first measurement device.

The method may also involve forwarding the new health data to an appropriate health record of an appropriate health care service based on said mapping, storing the heath data in an appropriate data store based on said mapping and/or performing some processing on the data based on said mapping.

In another aspect of the invention there is provided an apparatus for mapping health data acquired by at least a first measurement device which is useable by a plurality of users to an appropriate health record, the apparatus comprising a processor configured to: receive new health data acquired by at least said first measurement device; identify the user to which the new health data relates; and map said health data to at least one health record for said user; wherein the processor is configured to identify at least one item of context data associated with said new health data; and determine whether said context data corresponds to a known context for at least one user.

The apparatus of this aspect of the invention may perform all of the steps of the method as described above. The apparatus may be a telehealth hub apparatus.

Another aspect of the present invention relates to a computer program, especially on a computer readable medium, which, when run on a suitable processor of a device, performs the method as described above.

### BRIEF DESCRIPTION OF THE DRAWINGS

Embodiments of the invention will now be described, by way of example only, with reference to the following drawings, of which:

FIG. 1 illustrates a general telehealth system;

FIG. 2 shows a flow chart of a method of mapping new health data to an appropriate health record according to one embodiment;

FIG. 3 illustrates a telehealth hub according to one embodiment of the invention.

### DETAILED DESCRIPTION OF EMBODIMENTS

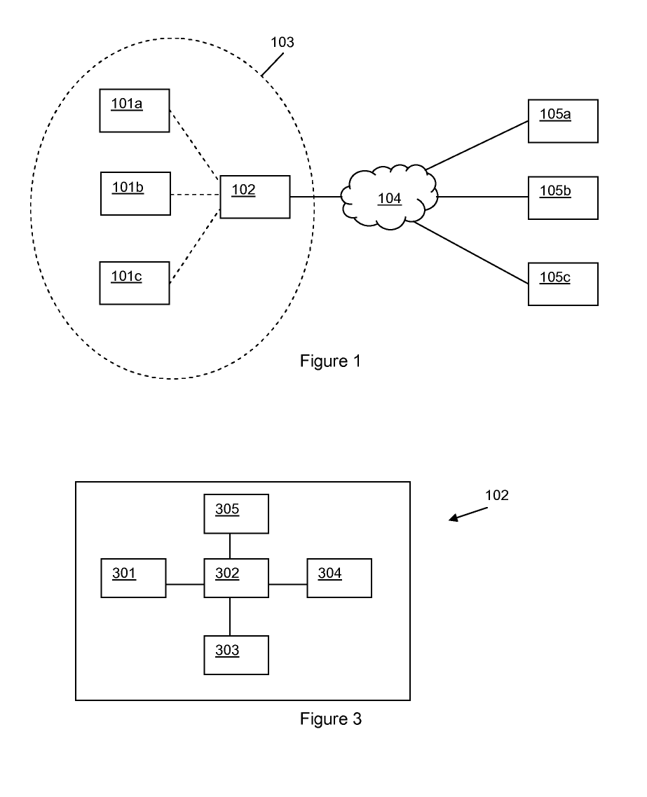

FIG. 1 illustrates generally an example of a possible telehealth arrangement. A number of measurement devices 101a-c used for health monitoring may be used by individuals to acquire health data about themselves or others in their care. As an example measurement device 101a may be a blood pressure monitor, measurement device 101b may be a glucometer and measurement device 101c may be a weighing scale although it will be appreciated that other measurement devices may additionally or alternatively be used. The health data acquired by these measurement devices may then be transmitted to a remote healthcare service for recording and/or analysis.

Whilst some measurement devices may be able to communicate directly with a healthcare service typically a local apparatus 102, referred to herein as a telehealth hub, is used to collect data locally and then transmit the data to the health services. Thus each of the measurement devices 101a-c is adapted to communicate with the telehealth hub 102. The measurement devices 101a-c may be arranged to communicate with the telehealth hub wirelessly via any suitable wireless protocol and/or via any suitable wired connection, i.e. relevant measurement device could be plugged into the telehealth hub in order to transfer data. The measurement devices may be arranged to transfer data automatically when new data is acquired, provided that a connection with the telehealth hub is established, and/or to record measurement data in a local memory and then transmit it to the telehealth hub periodically or at user initiated times, for instance when a connection with the telehealth hub has been established.

The telehealth hub 102 and measurement devices 101a-c may all be located in an environment 103, such as a home environment, which is remote from a healthcare provider. The measurement devices 101a-c may be used within the home environment although at least some measurement devices may be portable and usable in other locations. Such data may be stored in the measurement device and then uploaded to the telehealth hub when the user returns home.

The telehealth hub 102 is configured to receive the data from the measurement devices 101a-c and to transmit data to the healthcare services 105a-c, for instance via the internet 104. The telehealth hub may therefore have a suitable internet connection although in other embodiments the telehealth hub may be arranged to transfer data via a suitable mobile telephone network or any other remote communication network. In some embodiments the telehealth hub may be a dedicated telehealth hub apparatus but in other embodiments another device which is already suitable for remote communication may be configured to act as a telehealth hub, for instance a desktop or laptop computer, a mobile telephone, a set-top entertainment box or the like. It will be appreciated that if the telehealth hub is implemented in a portable device with a communications facility, such as a mobile telephone or portable computer, then the telehealth hub may itself be used in other environments than the home environment 103.

Conventionally such telehealth systems were used to acquire data about one specific patient and provide such data to a single healthcare service. Thus each of the measurement devices 101a-c would be specific to one individual and all data collected from said devices by the telehealth hub would be transmitted to a single backend health service.

Increasingly however such telehealth systems are being considered for acquiring data for a plurality of different healthcare services. Thus, for example, healthcare service 105a could be a weight loss or fitness service, healthcare service 105b could be a diabetes service and healthcare service 105c could be a personal heath record database maintaining an accurate and ongoing health record. At least some of these healthcare services 105a-c may only require a subset of the health data acquired by measurement devices 101a-c. For instance, taking the example given above where measurement devices 101a-c are a blood pressure monitor, a glucometer and a weighing scale respectively, only data from the weighing scale 101c may need to be transmitted to the weight loss/fitness service 105a whereas data from all the measurement devices may need to be transmitted to both the diabetes service 105b and the heath record database 105c.

At least some of the measurement devices 101a-c and the telehealth hub 102 may also be shared between multiple users, for example different family members. For instance, consider two people who live together and share the telehealth hub 102. Both may be subscribed to the weight loss or fitness service 105a and also to the personal heath record database 105c. Both individuals may therefore use the blood pressure monitor 101a and weighing scale 101c as part of an ongoing measurement regime. Not all the measurement devices may be shared however. For instance only one individual may have diabetes and be subscribed to the diabetes service 105b and thus only this individual may use the glucometer 101b.

In general therefore telehealth hub 102 may receive data from the measurement devices 101a-c relating to multiple users. The telehealth hub needs to be able to identify data that relates to an individual user in order to supply such data to the correct healthcare services 105a-c and, for each health care service, to identify the appropriate health record for that user. The telehealth hub may also be configured to store the health data locally, either in a memory within the telehealth hub or via an external storage such as a user's computer so that a user can view their historic data. The telehealth hub again therefore needs to be able to identify data that relates to an individual user to be able to store the data correctly.

Some measurement devices may have the ability for a user to select an appropriate user ID/user profile on the measurement device when taking a measurement and thus associate the acquired data with a particular user. Thus when measurement data from that measurement device is transmitted to the telehealth hub the identified user ID for that measurement device may be used to identify the appropriate accounts on the healthcare services 105a-c for that specific user. In other words blood pressure monitor 101a for example may allow a user to select a user ID on the device. Thus a first user, John say, may be associated with user ID1 on the blood pressure monitor and second user, Mary say, may be associated with user ID2 on the blood pressure monitor. The blood pressure monitor will also be associated with a unique device ID on the telehealth hub. Thus when measurement data is received at the telehealth hub from a device with an ID corresponding to the blood pressure monitor the telehealth hub will associate any such data tagged with user ID1 with the relevant health records for John and any data tagged with user ID2 with the relevant health records for Mary.

However some measurement devices may not have the ability to associate acquired data with a user ID. Also, even where a measurement device does have the facility to associate a user ID with data being acquired a user may forget to change a previously selected user ID or may select the wrong ID by accident and thus the data may be associated with an incorrect user ID.

Embodiments of the present invention therefore use context data regarding the measurement to identify or verify appropriate health records to which acquired new health data should be mapped, i.e. to identify the relevant user for which the new health data relates so that the data can be forwarded to the relevant accounts of the health services, stored in an appropriate data store for that user and/or processed appropriately for that user. The embodiments identify a user to which the new health data relates by identifying at least one item of context data associated with the new health data and determining whether said context data corresponds to a known context for at least one user.

The context data is data regarding the circumstances in which the new health data was acquired and/or the relationship of the new health data to other measurement data associated with a particular user.

Thus, for example, the context data may comprise the time of acquisition of the new health data. The time that the measurement was acquired could be compared to known times that various users tend to acquire measurements. Thus a known context may be the known times of typical measurements. For instance a first user of a measurement device may routinely take a measurement in the morning before going to work, whereas a second user may routinely take a measurement in the evening. Thus if the measurement data were acquired at 07:30 on a weekday the context would suggest that the data relates to the first user. Time windows associated with the various users of the measurement device could be user defined, for instance the user interface of the telehealth hub 102 may allow a user to set defined time windows for measurements to be taken for that user. In other embodiments however various trends associated with particular users may be identified from historical data, either by periodically analyzing the historical data or by forming a model when data is added. The model may be refined as further data is added. As will be described in more detail later the telehealth hub may use a probability model with the context data to determine a likelihood or confidence value that the new health data relates to a specific user.

The time of acquisition of the measurement data may also be used in relation to the time of acquisition of data from other measurement devices. For example if measurement data from two measurement devices were received and the time of acquisition of the measurements is the same or very similar for both devices this could indicate that the same person was using both measurement devices, either at the same time or consecutively. In other words the context data may comprise other measurement data acquired within a set period of the new health data.

Some measurement devices may often be used at the same time, for instance a heart rate monitor may be used at the same time as a pedometer or a GPS distance tracking device when exercising. Likewise some measurement devices may tend to be used consecutively with a short gap between measurements. For example one particular user may tend to take a blood pressure measurement and a blood glucose measurement in one measurement session. Thus data acquired using a blood pressure monitor 101a which is acquired within a short time of data acquired by a glucometer 101b may indicate that the same user was responsible for both measurements. The telehealth hub may therefore be configured with a list of measurement devices that are often used simultaneously or consecutively. It will, of course, be appreciated however that some measurement devices may be used continuously by a particular user or for very long periods of time, for instance some wearable or medically implanted measurement devices. If a first measurement device is used continuously by one user then any use of a second measurement device, whether by the same or a different user, will result in some data being acquired at the same time. The list of measurement devices which may be used simultaneously or consecutively, which represents a known context, will therefore be restricted to those measurement devices which are used periodically or occasionally.

This list could be user defined and/or derived from analysis of previous measurement data for which users have been identified. Thus if data from two or more such measurement devices is received and the time or acquisition of the measurement data is substantially the same, or within a defined time window, for each data set then the telehealth hub may use such context data as an indication that all these data sets correspond to the same user. In this case if a first such measurement device does not allow for identification of a particular user but a second such measurement device does, the user ID from the second measurement device may be used to identify the relevant user for the data from the first device. For example if data from a pedometer say is received which does not indicate a particular user the telehealth hub may look at the time of acquisition of the data. If the time of acquisition substantially matches that received from a heart rate monitor, which is often used at the same time as the pedometer, then any user ID identified for the data from the heart rate monitor may also be used for the data from the pedometer.

Even if the first measurement device also allows use of a local user ID for identification of a relevant user the two user IDs can be compared by the hub to ensure that they relate to the same user. If there is discrepancy in the user identified by each device the telehealth hub may prompt for manual input to resolve the potential conflict—this could therefore highlight an error in selecting the relevant user on a particular measurement device.

In some instances one particular measurement device may be used by a single user only and thus in effect use of such device indicates a particular user even in the absence of a defined user ID. For example, if a glucometer 101b, say, is used by only one user, say John, then the telehealth hub, which is shared between multiple users, may associate any data received from the glucometer with that specific user, i.e. John. If that user, i.e. John, also uses another measurement device which is shared with other users and typically uses both measurement devices at roughly the same time then again the time of acquisition of the data from a shared device can be considered in relation to any data acquired from the measurement device associated with a specific user in order to identify a likely user.

For example, the glucometer 101b may often used by user John at approximately the same time as another measurement device, say blood pressure monitor 101a. In such a case, if the telehealth hub receives measurement data from blood pressure monitor 101a, and such data was acquired at nearly the same time as data which was acquired using the glucometer this could be used to indicate that the same user was using both measurement devices and, as only one user, John, is associated with the glucometer the data from the blood pressure monitor may also be associated with John.

In some instances if a first user typically tends to use two or more measurement devices simultaneously or consecutively but another user only uses one of said measurement devices then when any data is received from the shared device the presence or absence of data acquired at substantially the same time from the other device may be used to identify the relevant user. Thus if John say tends to take a blood pressure reading at the same time as a blood glucose reading and Mary also takes blood pressure readings but does not take any blood glucose readings, then if data is received from the shared blood pressure monitor the telehealth hub may determine whether there is also data acquired at substantially the same time by the glucometer. If there is data acquired at substantially the same time from both devices this could indicate the data is associated with John, whereas if there is data from the blood pressure monitor alone this could indicate the data is associated with Mary. In other words the context may be the time of acquisition of measurement data in relation to time of acquisition of data using other measurement devices and the telehealth hub may use the absence of a substantially simultaneous measurement using a specific measuring device to discount the data from being associated with a specified user.

It will of course be appreciated that when data is received from one measuring device the absence of substantially simultaneous data from another measuring device, such as glucometer 101b, could be due to a failure of communication or the fact that such data has not yet been uploaded to the telehealth hub. The absence of such data may therefore generally only be used when the telehealth hub has a positive indication that no such data exists. For instance in a wireless embodiment the telehealth hub may interrogate the relevant measurement device(s), i.e. the glucometer in this example, to determine whether any such data exists. Additionally or alternatively the telehealth hub may maintain a record of the time of last update from a measuring device and may only identify a positive absence of data if there has been an upload from the relevant device more recently than the period in question.

The context data may additionally or alternatively comprise location data regarding the location where the measurement was acquired. Some measurement devices may be able to determine their location, for instance via GPS. The location at which the measurement is taken may therefore be recorded. This may be particularly useful for measurement devices which may be used away from the environment 103 where the telehealth hub is located. For example a user may take a portable measurement device to different locations, for example their place of work, and use the measurement device to acquire some measurements. A measurement acquired at a first location, which is different from the home location, may therefore be linked with a specific user. Known locations where a particular user is known to take measurements may therefore provide a known context.

The context data may additionally or alternatively comprise data regarding the relative proximity of the measurement device used to acquire the data and one or more personal devices associated with a particular user at the time when the measurement data is acquired. The relative proximity of the personal devices to the measurement device may be detected by the measurement device itself and/or by the telehealth hub.

As mentioned above some measurement devices may be associated with one particular user only and thus may be considered a personal device of that user. If such a device is typically active only when taking measurements then detection of such an active device may be taken as an indication that the personal device, and hence such a user, is in the vicinity. This is especially the case for a measuring device which is medically implanted into a patient. An implanted measurement device can clearly be identified with that specific patient and thus comprises a personal device. Thus if data is acquired by a measurement device and an active personal device associated with a user is in relatively close proximity at that time this could be used to indicate that the data acquired by the measuring device could be associated with that user. Additionally or alternatively the absence of a personal device, especially one which is an implanted device, may be an indication that the measuring device is not being used by that specified user.

At least some of the measurement devices 101a-c may be able to identify other measurement devices, including a personal measurement device, within a short range of that measurement device. For example using a suitable wireless type protocol a measurement device may be able to detect and identify any personal devices within a short range of the measurement device. Thus the measurement device itself may be able to determine the relative proximity of any personal devices simply be detecting any such devices in range. Additionally or alternatively where a measurement device is used within the same environment 103 as the telehealth hub 102, and the data is transferred immediately to the telehealth hub, then the telehealth hub may itself determine whether any personal devices are within range. Again if data is being received from a first measurement device in substantially real-time, and thus in range of the telehealth hub, and a personal device associated with a specific user, say John, is also in range of the telehealth hub this may mean that the data from the first measurement device could be associated with the specific user, i.e. John. Likewise if the personal device associated with the specified user, i.e. John, is not in range this may indicate that the relevant personal device is not in the proximity of the measurement device and that the data being received should not be associated with John.

The telehealth hub may be arranged to maintain a record of the times at which the various measurement devices and/or personal devices are in range of the telehealth hub. If data is subsequently received from a first measuring device, the time at which the measurement was taken can be identified and the record checked to determine what measurement and/or personal devices were in range of the telehealth hub at that time. If both the first measurement device and a personal device associated with a specific user, say John, were in range of the telehealth hub and active at the time that the measurement data was acquired then the devices were in relative close proximity and it is possible that the data relates to the specific user, i.e. John. However if the first measurement device was in range of the telehealth hub at the relevant time but the personal device associated with John was not, or vice versa, this may indicate that the data is not associated with John.

In some embodiments the personal device may not comprise a health measuring device and may comprise some other device that is personal to a specific user. For instance the telehealth hub and/or measurement devices may be able to communicate with a mobile telephone of a user. Consider that first and second users share some measuring devices and each user has a mobile telephone which is registered with the telehealth hub. If data is received from a measuring device and the mobile telephone of the first user was within range of the hub at the time the measurement was taken but the mobile telephone of the second user was not in range this may indicate that the first user was present but the second user was absent and thus that the data from the measuring device pertains to the first user. In general though a personal device may be any device which is associated with a user and which is detectable within a certain range. As described above personal devices such as mobile telephones can have various communication protocols such as Bluetooth™ or WiFi for example. The telehealth hub may detect whether such devices are in range or on the same network while the measurement is taken based on, for example device name or id or mac address of the personal device. The term personal device, as used herein, will refer to devices which have a primary utility which is not identification, e.g. measurement, mobile communication etc. Thus a personal device is not a device used solely for identification purposes such as dedicated RFID tag or the like. Whilst dedicated identification tags may be used in clinical settings they would not be appropriate for a home environment.

The context data may additionally or alternatively comprise data relating to the actual measurement value or values when compared to previous measurement data values for at least one user. Depending on the type of data the current value(s) may be compared to a known context comprising one or more previously acquired values and/or an average or modeled value based on previous results.

The new measurement value(s) may be compared to the previous measurement values based on a physiological model. The model may be used to determine expected ranges within which a new measurement may fall, given the previous measurements and the physical characteristic being measured. For instance if the data is weight data acquired with a weighing scale a model may be used to determine an expected weight range given the previous data for a particular user. For example a relatively simple model for weight data could be whether the new measurement value falls within a defined amount, for example within 5 kg or within a tolerance of 10%, of the average of a number of previous measurements, e.g. the last three measurements.

In some instance the time that has elapsed since the previous measurement may also be used, for instance the expected range in which a new weight measurement may be expected to lie may be smaller if the new data is acquired one day after a previous reading as compared to one month after previous reading.

For some measurements the value of the measurement may exhibit a natural variation but the average over a period of time will tend to be stable. For example a glucose measurement will typically tend to vary throughout the day but will exhibit a reasonable stable average value of the course of the whole day. Thus the appropriate model may take such variation into account. In the case of some measurements the variation may follow the same general pattern over a period of time, for example the glucose readings may vary following the same general pattern over the course of an average day. The model may be arranged to predict the expected value based on the time that the measurement was acquired.

Additionally or alternatively where the health data comprises a series of measurements acquired over a period of time, the context data may be determined by processing the data. For instance the average value of the series of measurements could be determined, a maximum or minimum value identified and/or a maximum variation in measurement value. The exact type of analysis conducted on the health data to determine the context data may vary according to the model used for comparison.

A model could also be configured to take an ongoing treatment or fitness regime and/or could be provided with an expected longer term trend based on a known regime. Thus for example a patient on a treatment regime for high blood pressure may be expected to exhibit a gradual reduction in the average value of blood pressure measurements over the course of the treatment regime.

The telehealth hub may be provided with a variety of types of physiological model for various types of health data that may be acquired and/or the telehealth hub could be configured to download an appropriate model when a new measurement device is registered with the telehealth hub. The measurement device itself could be provided with an appropriate model stored in a memory which could be uploaded to the telehealth hub for use at the point at which the measurement device is registered with the hub.

The appropriate model or models will therefore form part of the software configuration on the telehealth hub and should be configurable. Configuring the models may be done locally on the telehealth hub and/or the models may be configured remotely by approved services such as any of the health care services which the telehealth hub is registered with or by the manufacturer or distributor of the relevant measurement device or by a suitably experienced or qualified healthcare professional.

As mentioned above, for measurements which are relatively slow to change, such as weight, a relatively simple model may be implemented allowing a maximum variation based on a maximum amount or maximum percentage—which may increase with time between measurements. For measurements with a faster rate of change, such a blood pressure, blood glucose level etc. the model will more likely be based on historic data indicating the pattern of variation and maximum variation.

It will be appreciated that for some measurements there may be a significant degree of overlap between the expected ranges for various users and thus context data relating only to the current value of the measurement be insufficient to uniquely identify a user. However it will be appreciated from the foregoing that embodiments of the present invention use context data relating to the circumstances in which the measurement is taken, e.g. time, location, proximity of other devices etc. By using such context data relating to the circumstances in which the health data was acquired the appropriate user may be identified or verified in circumstances where a comparison of measurement values to previous values would not allow identification of a user.

It will of course be appreciated that any or all of the above mentioned types of context data may be used together to identify or verify a user of a shared measurement device and thus correctly map data from the measurement device to the appropriate health records for that user. As will be described later the telehealth hub may be arranged to use one or more items of context data to determine a confidence value that the new health data does relate to a specified user.

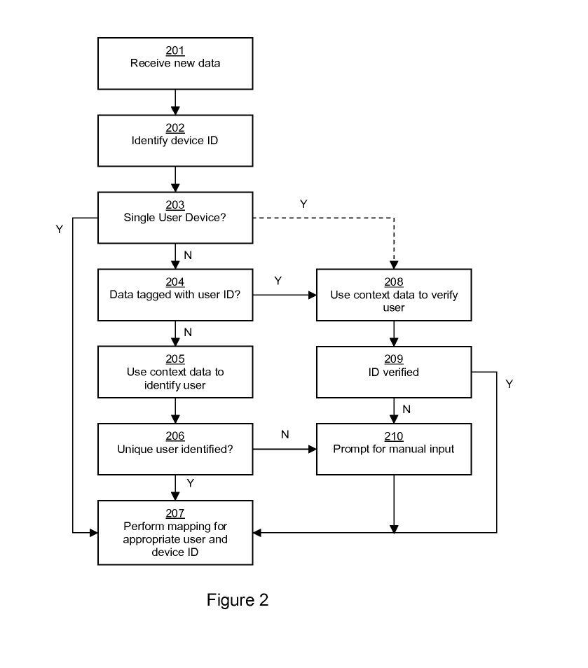

FIG. 2 shows a flowchart illustrating one example of how the telehealth hub 102 may process new data.

At step 201 the telehealth hub receives new data from a first measurement device, which, as mentioned above, may be via any suitable wired connection although conveniently may be via a suitable wireless connection. As also mentioned above the first measurement device may transfer data in real-time or as soon as a measurement is acquired, as long as there is a suitable data connection between the first measurement device and the telehealth hub. At step 202 the telehealth hub identifies the device ID of the first measurement device. The telehealth hub stores a unique device ID for each measurement device which is registered with the telehealth hub. For typical health measurement devices the unique device ID is allocated to the measurement device during manufacture and this unique device ID may be communicated to the telehealth hub. However for any measurement devices which do not have such an internal unique ID the telehealth hub may allocate such a device with a unique device ID when it is first registered with the hub.

At step 203 the telehealth hub, based on the device ID, determines whether the first measurement device is associated with a single user or whether the device may be shared between users. Whether the device is associated with a single user or whether it is shared between multiple users may be user defined, for instance when a measurement device is first registered with the telehealth hub, the user may be prompted to indicate whether or not the device is a single user device. The default may be that the device may be shared between users.

If the first measurement device is registered as a single user device then, for such data the identification of the device ID provides the indication of the type of data received and the specific user to which it relates. Thus in one embodiment the date received may be mapped to appropriate health records for that user and device ID as will be described later. In an alternative embodiment however, illustrated by the dotted arrow, the telehealth hub may then perform acceptance or verification of the data as will be described below.

If the device ID indicates that the first measurement device may be a shared device then the next step 204 may be to determine whether or not the data is tagged with a known user ID for that measurement device. If the first measurement device allows a user to select a local user ID or user profile, and such a user ID or profile has been selected, then the data will be tagged with a user ID. Specific user IDs or user profiles may be set up on the measurement device itself by the individual users and/or the telehealth hub may be arranged so that a new user of the telehealth hub can register directly with the telehealth hub and the telehealth hub will then communicate with all measurement devices which allow for local user IDs and which are registered as shared measurement devices to automatically set up an appropriate user ID on the local device.

The telehealth hub determines whether the local user ID used to tag the data is known for the relevant device ID. If so then the user and device ID are both known and the telehealth hub could map the data to the appropriate health records. However in this example the telehealth hub uses context data to verify the user.

Thus if there is a known user ID associated with the data the telehealth hub may proceed to step 208 where the context data of the measurement data is used to verify that the data does indeed correspond to the identified user ID.

The verification may use any or all of the context data discussed above. The verification performed may involve applying an acceptance function to the data based on the device ID and user ID. The acceptance function may vary depending on the device ID and user ID. In effect relevant context data determined by the acceptance function is compared to a known context for that user.

Typically the acceptance function may include a component based on the actual value of the measurement (or if the health data is a series of measurements a value such as average measurement value, maximum or minimum value, maximum variation etc.) and an expected or likely range based on previous values and a physiological model. For example, for a device ID indicating a weighing scale the acceptance function may include determining whether the current value is within 5 kg of the average value of the previous three measurements for that user ID.

For some measurements however the variation in expected measurement values for individual readings may be relatively large, or it may happen that two or more users have expected ranges for a measurement value that have significant overlap, and thus it may not be practical to use measurement value to provide verification. Thus the acceptance function may additionally or alternatively include context information regarding the circumstances in which the data was acquired as described above. For example the acceptance function may include comparing the time of acquisition of the data with a time window for typical measurements for that device ID corresponding to the relevant user ID and/or comparing the location of the first measurement device when the measurement was taken with a list of typical locations for that user. In addition for at least some user IDs the acceptance function may also comprise identifying whether another measurement device, associated with the same user, was used to acquire measurements at the same time or whether a personal device associated with that user was in proximity of the first measurement device.

Once the acceptance function has been applied the telehealth hub will determine whether or not the relevant user ID has been verified. The telehealth hub may require that all components of the function are satisfied in order to verify the user ID or alternatively a confidence value could be generated indicating how likely it is that the new data actually does correspond to the identified user ID. A confidence value over a certain threshold could be taken as a verification of the user ID. In some embodiments the verification step may also involve applying the acceptance functions for other users of the telehealth hub for that specific device ID to the new data so as to determine a confidence value in relation to all possible users. In this case a positive verification of the user ID indicated by the first measurement device may require that the data does not present a significantly better match for another user ID. The confidence value may be derived using a probability model based on all the available context data. The more that the context data points to a specific user the higher the probability that this measurement should be associated with a certain user and the higher the confidence value. Thresholds may be applied such that a confidence value over a certain threshold, for example a set probability such as 90%, is taken to be a firm indication that the new health data is associated with the specific user (unless there is more than one user for which the confidence value is above the threshold).

If the user ID that the data is tagged with is verified the telehealth hub may then proceed to step 207 to map the data to the appropriate health records. If however the verification step results in the identified user ID not being verified, for example the confidence value is below a set threshold, then the telehealth hub may prompt for user input to confirm that the user ID specified on the first measurement device was indeed correct and that the data does correspond to that user. This can help detect errors in selection of user ID on the device, for instance when a user accidentally selects the wrong ID or forgets to change the user ID from the previous user of the device. If manual input is required than once the identified has been manually confirmed or, in the case of an error, the correct user has been identified, the new health data can be mapped 207 to the appropriate health services as will be described below.

Referring back to step 204 if the data received by the telehealth hub is not tagged with a user ID, or if there is a user ID but it is not known to the telehealth hub, i.e. that combination of user ID and device ID does not have an associated mapping, then the telehealth hub will try to use to context data in step 205 to identify the user.

The step of using context data to identify the user may in effect be very similar to the verification step 206 described above but applied to all possible users of the first measurement device which are registered with the telehealth hub. Thus the step of identifying the user may comprise applying an acceptance function for that device ID for each possible user to determine whether the context of the new data corresponds to the typical context for any of the known users. The result may therefore identify one or more users where the relevant acceptance functions indicate a match or where the confidence value is above a certain threshold.

At step 206 if there is only one such user identified then the telehealth hub proceeds to step 207 to map the new data to the appropriate health records for that user ID and device ID combination. However if there is more than one possible user identified then the telehealth hub may proceed to step 210 to prompt for manual input to identify the appropriate user.

The mapping step 207 relies on the device ID and a user ID which are identified and verified as described above. Thus a tuple comprising the device ID, which in effect identifies the type of data, and a user ID is used to determine the mapping. The user ID forming part of the tuple may be any of the local user ID on the device, an notional user ID which has been determined for the device or a hub user ID.

Thus, for example, consider that two users, John and Mary share a telehealth hub 102 and some measurement devices 101a-c. Measurement device 101a is a blood pressure monitor which supports local user IDs and measurement device 101c is a weighing scale which does not support local users IDs. Both of these devices are shared by both Mary and John. Measurement device 101b is a glucometer which is used by John alone. Both Mary and John are subscribed to a weight loss/fitness service 101a to which weight data should be sent. Both Mary and John are also subscribed to a personal health record database service 101c to which all data should be sent. John is further subscribed to a diabetes service to which blood pressure and blood glucose measurements should be sent.

The telehealth hub may therefore have a mapping table along the lines shown in Table 1 below:

TABLE 1

| | Input Data | | | |
|---|---|---|---|---|
| | Device | User | Identified | |
| Device | ID | ID | User | Output Account |
| Blood | 1 | 1 | John | John@DiabetesServiceID |
| Pressure | | | | John@DatabaseServiceID |
| Monitor | 1 | 2 | Mary | Mary@DatabaseServiceID |
| Glucometer | 2 | — | John | John@DiabetesServiceID |
| | | | | John@DatabaseServiceID |
| Weighing | 3 | — | John | John@DatabaseServiceID |
| Scale | | | | John@FitnessServiceID |
| | 3 | — | Mary | Mary@DatabaseServiceID |
| | | | | Mary@FitnessServiceID |

Thus for all received data the telehealth hub will receive a device ID. The device ID will uniquely identify the measurement device to the telehealth hub. Note that the telehealth hub does not necessarily need to know what type of measurement device is being used only the relevant acceptance functions for data to identify/verify users and the relevant accounts to which data should be mapped. Where available the data will also be tagged with a local user ID. Thus as shown local user 1 on the blood pressure monitor 101a corresponds to John and local user 2 corresponds to Mary. The local user ID should uniquely identify, on that device, the relevant user. It will of course be appreciated that it is the combination of device ID and local user ID which identifies a user and thus the same user may have a different local user ID on a different measurement device and/or the same local user ID could be used on two different measurement devices to identify different users, i.e. Mary could be identified as local user 1 on a different measurement device.

When the telehealth hub receives data from a device which is shared between users and which is tagged with a local user ID, such as data from the blood pressure monitor, the hub may verify the user ID as described above. In some embodiments the hub may have a hub user ID and thus may identify the relevant hub user ID. In other embodiments the hub may simply verify the local user ID. If the user ID is verified the combination of the device ID and user ID (the hub user ID where present or otherwise the local device ID) is used to determine the relevant mapping of the data. Thus data from device ID 1 and local user ID 1, i.e. identifying blood pressure data for John is mapped to John's personal health record, i.e. his account, at the diabetes service 105b and also to John's personal health record at the database 105c. Likewise data from device ID 1 and local user ID 2, i.e. Mary's blood pressure data, is mapped to Mary's accounts at the database service 105c.

If data is received from a device which has a single user only, such as data received with device ID 2 from the glucometer, this data may not need a local user ID. The data may potentially be verified as described above and then mapped to the appropriate accounts, in this example John's personal health records at the diabetes service 105b and database service 105c.

Data received from the weighing scale 101c is not tagged with a local user ID as the weighing scale may not have the capability to allow different user profiles. Thus when data is received which is identified with device ID 3 the telehealth hub uses the context information to try to determine which of the users of the telehealth hub the data corresponds to. If the telehealth hub allows a hub user ID then the hub will try to identify the relevant hub user ID. Alternatively a notional local user ID could be determined for that specific device ID. If the relevant user can be determined then the data is mapped based on the device ID and user ID. Thus if user John is identified the data may be mapped to John's records at the weight loss/fitness service 105a and the database service 105c and if Mary is identified as the user then the data will be mapped to Mary's accounts at the same services.

It can therefore be seen that the embodiments of the present invention allow a telehealth hub to apply flexible mapping rules, which may be configurable by a user, to allow data from a range of measurement devices to be mapped to the appropriate health records, i.e. accounts, of a range of healthcare services. The embodiments also provide a means of identifying the relevant user of shared measurement devices even in the absence of a local user ID on that device, thus avoiding the need to manually identify the relevant user each time data is uploaded. The embodiments also provide a check in the cases where a local user ID is supplied that the data uploaded does indeed correspond to that user.

Once the new health data has been appropriately mapped to a health record of a health service the telehealth hub can forward the data to the relevant record. In some instances however the health data may be processed by the telehealth hub before forwarding. For instance a series of measurements from the same measurement device for a particular user may be averaged over a certain period prior to being forwarded. Thus only the average data may actually transmitted by the telehealth hub. In other instance the health data may be processed into a form required by a particular health service. For instance whilst the telehealth may receive weight data for users a particular health service may use a measure of BMI. Thus the telehealth hub may use context data as described above to identify or verify the user and then apply appropriate processing to determine a BMI value for that user based on the weight data and forward the BMI value to the health service.

The examples given above describe the telehealth hub mapping the health data to the health records of remote health services. However additionally or alternatively the telehealth hub may use context data to map the data to a local health record, i.e. an account on the telehealth hub or a local storage device, for storage or processing. For instance a user may wish to store a local version of their health data on the telehealth hub or on a local networked storage device such as their personal computer or mobile telephone. The telehealth hub may therefore map the health data to the appropriate record within the telehealth hub or local storage device and store or forward the data appropriately. The telehealth hub may additionally identify or verify the user to map the health data to a health record on the telehealth hub which specifies some processing to be applied to the data for that user. For instance the telehealth hub may map the new data to a user for whom there is a monitoring regime. Having mapped the data to the appropriate record the data may be processed to ensure the data is within a safe level. If the data is outside of an expected safe zone or zones the telehealth hub may generate some sort of alert, for instance a message to specified recipients such as the user in question, a local carer or a health care professional.

FIG. 3 illustrates one embodiment of a suitable telehealth hub 102. A local communications unit 301 is configured to receive the data from the measurement devices and may comprise a wireless receiving unit and/or it may be connected to various sockets on the hub (not shown) for wired connections. Data received by the local communications unit 301 is passed to a processor 302 which is configured to identify or verify the user associated with the new data. The processor may therefore apply the process as generally described above in relation to FIG. 2. The processor 302 may therefore identify the device ID for the new data and interrogate memory 303 to determine whether the device is a shared device, the registered users for the device and the relevant acceptance function for data from such device. This may include lists of devices that are usually used at the same time as the device in question, defined time windows for measurements using such device, expected ranges for new measurements for users based on a physiological model etc.

If the processor determines or verifies the identity of the user the processor may then access the appropriate mapping from memory 303 and then pass the data to a transmit module 304 for onward transmission to the relevant personal health records of the indicated health services. The transmit module may be connected to the internet or may be a radio module for transmission via a mobile phone network for example. The transmit module will attempt to send the data to the relevant health records using suitable encryption protocols.

If the processor 302 determines that no firm decision on the identity of the user can be made because it lacks some information, for instance where the measurement device in question is often used at the same time as a second measurement device and the last upload from said second measurement device is before the period in question, then the processor may store the received data in the memory until an upload from the second measurement device has been received.

If the processor 302 however has all necessary information and fails to determine or verify the identity of a unique user that corresponds to the new data the processor may indicate this via a user interface module 305. The user interface module could alert the user via any suitable means such as a message on a display screen of the hub, providing a visual indication such as an alert light, providing an audible alarm and/or sending an email or text message to a nominated address/telephone number etc. via local communications unit 301 or transmit module 304. In another embodiment however there may be no direct user interface on the telehealth hub itself and the telehealth hub user interface module may be configured to communicate with a user interface program on a personal computer or mobile telephone or the like.

Whatever type of user interface is used the telehealth hub may typically indicate details about the measurement data in question, such as the time of acquisition, type of measurement etc. and ask for input as to which user the data actually corresponds to. In some instance a short list of possible users may be presented based on all users which are potential matches. The hub may be configurable so that no data regarding the actual measurement value is presented so as to maintain confidentiality of the actual data itself. In general any user of the telehealth hub may then be able to indicate that the relevant data should be associated with any user, although in some embodiments the users of the telehealth hub may be required to log onto the telehealth hub via a password or the like and should one user specify that the data corresponds to another specified user that specified user may be required to log on and confirm before the data is transmitted to the relevant records.

When any new data is identified with one individual, whether automatically or following user input, the relevant models held in the telehealth hub may be updated using the new information. This may include updating the data held for the physiological models, adjusting typical time ranges for measurements, associating unknown local device IDs with hub user IDs etc.

The user interface module 305 may also allow users to register themselves with the telehealth hub, to configure the mapping tables for the device ID and user IDs, to set various parameters for the acceptance functions, to identity single and shared user measurement devices and the like.

Embodiments have been described above wherein a telehealth hub 102 uses the context of measurement data received at said hub to determine or verify the identity of users of the telehealth hub and then map data to appropriate healthcare records. It will be appreciated however that the methods of mapping data to appropriate health records may additionally or alternatively be employed by the backend healthcare services providers, i.e. at healthcare services 105a-c. In this case the healthcare service may receive data from one or more telehealth hubs and/or directly from one or measurement devices. If receiving data direct from measurement devices the mapping may be applied in the same way as described above. If data is being received from a telehealth hub the mapping may be based on a three-tuple of hub ID, local device ID for that hub and local user ID. The local user ID may be a hub user ID or a local user ID tied to the device ID. In some instances there may not be any hub user ID or local device ID, in the other words the hub may simply forward all data from certain devices to a healthcare service and the healthcare service may use the context of the measurement data to map the received data to an appropriate health record for the known users of that hub.

Additionally or alternatively a measurement device may be arranged to use the methods described above in order to verify a selected user ID for that measurement device.

The examples and embodiments described above and as shown in the drawings are intended purely to illustrate the invention and the invention is not be construed as being limited to the arrangements describe above. Other variations to the disclosed embodiments can be effected by those skilled in the art in practicing the claimed invention from a study of the drawings, the disclosure and the appended claims.

In the appended claims the words “comprising” and “comprise” does not exclude other elements or steps, and the indefinite article “a” or “an” does not exclude a plurality. Any reference signs in the description should not be construed as limiting their scope. A method claim reciting a series of steps in a certain order does not preclude those steps being performed in a different order unless expressly stated.

1. A method of mapping health data acquired by a first measurement device which is useable by a plurality of users to an appropriate health record, the method comprising:
receiving new health data acquired by said first measurement device;
identifying the user to which the new health data relates; and
mapping said health data to at least one health record for said user; wherein
the step of identifying the user to which the new health data relates comprises:
identifying at least one item of context data associated with said new health data; and
determining whether said context data corresponds to a known context for at least one user;
wherein said context data used in the step of identifying the user comprises data regarding the circumstances in which the new health data was acquired and does not include a user ID tagged to the new health data.

2. A method as claimed in claim 1 wherein said context data comprises at least one of: the time of acquisition of the new health data; other measurement data acquired simultaneously within a set period of said new health data; the location that the measurement was taken; and the relative proximity of the first measurement device to at least one personal device associated with a specific user at the time of measurement.

3. A method as claimed in claim 1 wherein said context data comprises the time of acquisition of the new health data and said known context comprises known times for measurements using said first measurement device for a user.

4. A method as claimed in any preceding claim wherein said context data comprises other measurement data acquired within a set period of said new health data, wherein said known context comprises an indication of at least a second measurement device that has been used simultaneously with or within a set period of using said first measurement device, and wherein the method comprises identifying whether any other measurement data was acquired using said second measurement device within a set period of said new health data.

5. A method as claimed in claim 4 wherein said other measurement data acquired using said second measurement device is associated with a specific user and the presence of such other measurement data is used as an indication that new health data acquired using the first measurement device also corresponds to said specific user.

6. A method as claimed in claim 1 wherein said context data comprises the location that the measurement of the new health data was taken and said known context comprises one or more known locations for measurements using said first measurement device for a user.

7. (canceled)

8. (canceled)

9. A method as claimed in claim 1 wherein said context data comprises the relative proximity of the first measurement device to at least one personal device associated with a specific user at the time of measurement and the known context comprises an identification of known personal devices and the associated users.

10. A method as claimed in claim 9 wherein said personal devices comprise a measurement device associated with a single user only.

11. A method as claimed in claim 9 wherein the presence of a personal device associated with a specific user in relative proximity to the first measuring device at the time that the measurement was taken is used as an indication that new health data acquired using the first measurement device corresponds to said specific user and/or the absence of a personal device associated with a specific user in relative proximity to the first measuring device at the time that the measurement was taken is used as an indication that new health data acquired using the first measurement device does not correspond to said specific user.

12. A method as claimed in claim 1 wherein said new health data is tagged with a user ID and the method comprises determining whether said context data corresponds to a known context for the user corresponding to said user ID so as to verify the user ID.

13. A method as claimed in claim 1 performed by a telehealth hub apparatus configured to receive data from said first measurement device.

14. An apparatus for mapping health data acquired by at least a first measurement device which is useable by a plurality of users to an appropriate health record, the apparatus comprising
a processor configured to:
receive new health data acquired by at least said first measurement device;
identify the user to which the new health data relates; and
map said health data to at least one health record for said user; wherein
the processor is configured to identify at least one item of context data associated with said new health data; and determine whether said context data corresponds to a known context for at least one user;
wherein said context data used to identify the user comprises data regarding the circumstances in which the new health data was acquired and does not include a user ID tagged to the new health data.

15. A computer program on a computer readable medium which, when run on a suitable computer, performs the method of claim 1.
